(19) United States
(12) Patent Application Publication
(10) Pub. No.: US 2026/0203776 A1
(43) Pub. Date: Jul. 16, 2026

(54) IDENTIFYING PREFERENCES FROM STRUCTURED DATA AT SCALE USING LARGE LANGUAGE MODELS (LLMS)

(71) Applicant: Capital One Services, LLC, McLean, VA (US)

(72) Inventors: Kritika MITTAL, Dehradun, UT (US); Aashish BANSIWALA, Bangalore (IN); Rama Teja GAMPA, Bangalore (IN); Abhishek Kumar CHAUDHARY, Maharashtra (IN)

(73) Assignee: Capital One Services, LLC, McLean, VA (US)

(21) Appl. No.: 19/020,218

(22) Filed: Jan. 14, 2025

(51) Int. Cl. G06Q 30/0201; G06F 40/20

(52) U.S. Cl. CPC G06Q 30/0201; G06F 40/20

(57) ABSTRACT

Aspects disclosed provide system and methods for augmenting a large language model (LLM) for behavioral pattern detection. The system and methods incorporate custom tools and processes built around LLMs to enhance the functioning of LLMs and to allow the LLMs to better analyze account data with its context in mind, and to help deduce preferences, behaviors, or other nuanced patterns based on patterns detected in the account data.

### TECHNICAL FIELD

Aspects relate to generative artificial intelligence (AI), and specifically to large language models (LLMs).

### BACKGROUND

Artificial intelligence (AI) and machine learning (ML) based systems have become indispensable tools for identifying patterns that are typically not deducible by a human alone, or by a human with conventional non-AI/ML based computer systems.

One promising use case for AI/ML is in the area of behavioral pattern recognition. Often, it is useful to understand a person's behavior, which can also be linked to preferences. Once behavioral patterns and/or preferences are determined, the information may be useful in a variety of applications. For example, the information may be useful in determining purchasing preferences of a person, personalized marketing, personalized product design, custom services, etc. The information can also be used in health related fields. For example, behavioral patterns may be used to determine what patterns or behaviors a person has, which can then be linked to certain health conditions, diseases, etc., by for example linking environmental conditions or factors that a person exposes themselves to and linking these to known health conditions, diseases, etc. These insights may be used in treatment or preventative care.

The use of AI/ML systems can assist in uncovering these patterns through insights generated by LLMs. Thus, enhanced AI/ML tools and systems are needed to allow LLMs to provide these insights.

### SUMMARY

Aspects disclosed herein provide a system and methods for augmenting LLMs to aid in recognition of behavioral patterns. Recognition of behavioral patterns may be useful in many instances. One useful insight that may be obtained from behavioral patterns is identifying personal preferences. For example, the preferences may be those related to what products a person is interested in, lifestyle, etc. Once determined, the preferences may be used for many applications like personalized marketing, personalized product design, improved methods of marketing and advertising, etc.

Traditional methods of deducing user preferences is usually done by surveying people and asking them questions about likes/dislikes, interests, preferences, etc. For example, a person can fill out questionnaires or surveys with questions designed to extract these preferences. However, such questionnaire and survey data may not yield accurate results because a person may not answer the questions correctly, truthfully, or otherwise. Also, these surveys only capture preferences for a given instance in time. They do not account for changing patterns in the user's preferences or behaviors. These can vary significantly over time or under various circumstances.

The proposed system and methods seeks to provide a new way of performing behavioral pattern recognition. The system does this by implementing tools around LLMs to assist the LLMs in identifying behavioral patterns. In the use case given throughout this disclosure, the system will be tuned to identify preferences, specifically those of a person. The preferences will be used to identify what products or services the person may be interested in based on detected patterns of behavior. While the use case is given, it is by no means limiting. A person of skill in the art (POSA) will recognize by reading this disclosure how the system and methods may be adapted to other areas, such as detecting behavioral patterns that may be used in health related applications, such as linking behaviors to causes of disease or health conditions.

In aspects, the system can implement one or more computing devices to perform the aforementioned functionality. In aspects, the one or more computing devices can achieve the aforementioned functionality by processing structured tabular data, and shaping that data into a form that may be more effectively used by a LLM. The shaping can take the form of generating one or more natural language sentences from structured tabular data representing transactions of an account, where the account is one of multiple accounts. Once the one or more natural language sentences are generated, determined irrelevant information may be removed from the one or more natural language sentences to put them in a form that is better suited for the LLM. In aspects, the one or more natural language sentences can then be input into the LLM by incorporating them into a prompt generated to determine preferences of an account holder for the account. In aspects, the LLM can output a first output indicating preferences of the account holder. This first output may be transmitted to downstream components of the system for further processing. In aspects, the first output may be mapped to customer attributes determined by grouping semantically similar words using a clustering algorithm. The customer attributes refer to keywords that are meant to summarize or characterize the preferences output by the LLM. More will be discussed on what these customer attributes can comprise later in this disclosure. In aspects, the customer attributes can then be further mapped to preferred product attributes. The preferred product attributes refer to keywords that summarize or characterize the customer attributes but to a particular product or service. Again, more will be discussed on what these preferred product attributes can comprise later in this disclosure. In aspects, once the preferred product attributes are determined they may be transmitted to downstream components. The downstream components can then use these preferred product attributes to perform functions such as generating reports based on the preferred product attributes.

Certain aspects have other steps or elements in addition to or in place of those mentioned above. The steps or elements will become apparent to a POSA from a reading of the following detailed description when taken with reference to the accompanying drawings.

### BRIEF DESCRIPTION OF THE DRAWINGS

The accompanying drawings, which are incorporated herein and form a part of the specification, illustrate aspects of the present disclosure and, together with the description, further serve to explain the principles of the disclosure and to enable a POSA to make and use the aspects.

FIG. 1 is an example system for augmenting a LLM for identifying preferences according to aspects.

FIG. 2 shows how one or more natural language sentences are generated from structured tabular data according to aspects.

FIG. 3 shows an example prompt generated to determine preferences of an account holder according to aspects.

FIG. 4 is an example method of operating the system according to aspects.

FIG. 5 is an example architecture of the components that may be used to implement the computing devices of the system according to aspects.

### DETAILED DESCRIPTION

Aspects disclosed herein provide a system and methods for augmenting a LLM to aid in recognition of behavioral patterns. The system and methods provide an enhancement to existing LLMs that are not specifically trained to perform behavioral pattern recognition. The system and methods provide this enhancement by building tools to supplement LLM functionality and enhance the LLM's ability to detect behavioral patterns by performing a series of data transformations and data shaping prior to the data being input into the LLM. The system can then take the output of the LLM and perform some optimization steps to better map the preferences to customer attributes and ultimately preferred product attributes.

The approach of the system is to augment LLMs and improve on existing LLMs ability to perform behavioral pattern recognition in a cost effective way and one that scales. As is recognized by a POSA, LLMs are costly to train in terms of time and money. By using the approach outlined in this disclosure, LLMs may be further refined for a particular purpose, in this case behavioral pattern recognition, without the need to retrain the LLMs for the particular purpose. Rather, the tools described and built around the LLM can fill the gap in the training for the particular purpose. In this way, the system improves technology, specifically LLMs by improving the ability of LLMs to perform a particular function, in this case behavioral pattern recognition.

The following aspects are described in sufficient detail to enable those skilled in the art to make and use the disclosure. It is to be understood that other aspects are evident based on the present disclosure, and that system, process, or mechanical changes may be made without departing from the scope of aspects of the present disclosure.

In the following description, numerous specific details are given to provide a thorough understanding of the disclosure. However, it will be apparent that the disclosure may be practiced without these specific details. In order to avoid obscuring an aspect of the present disclosure, some well-known circuits, system configurations, architectures, and process steps are not disclosed in detail.

The drawings showing aspects of the system are semi-diagrammatic, and not to scale. Some of the dimensions are for the clarity of presentation and are shown exaggerated in the drawing figures. Similarly, although the views in the drawings are for ease of description and generally show similar orientations, this depiction in the figures is arbitrary for the most part. Generally, the disclosure may be operated in any orientation.

The term “module” or “unit” referred to herein may include software, hardware, or a combination thereof in an aspect of the present disclosure in accordance with the context in which the term is used. For example, the software may be machine code, firmware, embedded code, or application software. Also, for example, the hardware may be circuitry, a processor, a special purpose computer, an integrated circuit, integrated circuit cores, or a combination thereof. Further, if a module or unit is written in the system or apparatus claims section below, the module or unit is deemed to include hardware circuitry for the purposes and the scope of the system or apparatus claims.

The modules or units in the following description of the aspects may be coupled to one another as described or as shown. The coupling may be direct or indirect, without or with intervening items between coupled modules or units. The coupling may be by physical contact or by communication between modules or units.

### System Overview and Function

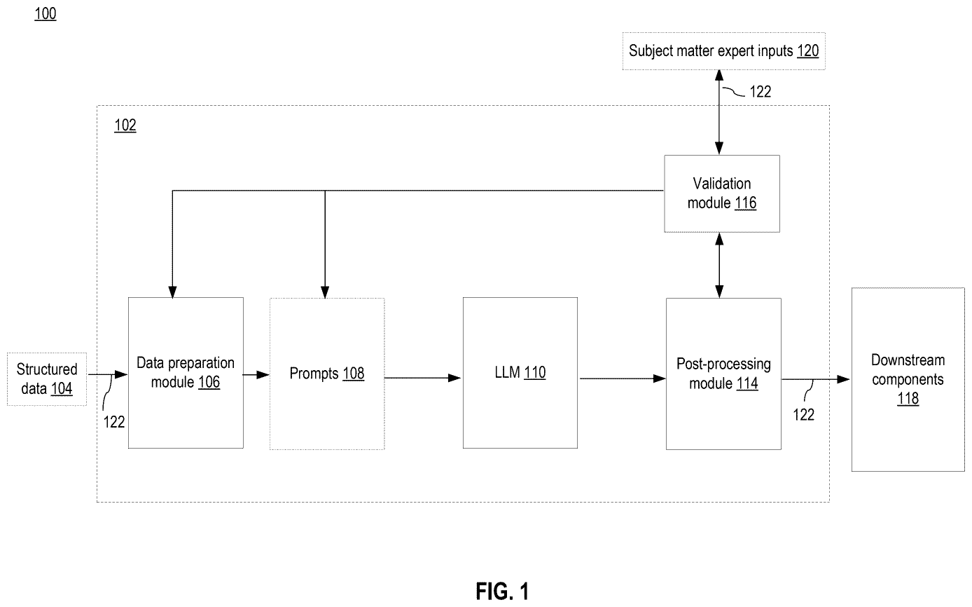

FIG. 1 is an example system 100 for augmenting a LLM 110 for identifying preferences according to aspects. In aspects, the system 100 may be implemented on one or more computing devices of backend computing infrastructure, including server infrastructure of a company, for example a financial services company, such as Capital One Services, LLC, of Delaware.

The backend computing infrastructure of the system 100 may be housed in a cloud-computing environment 102. The cloud-computing environment 102 can include server infrastructure. The cloud-computing environment 102 may be a public or private cloud service. A private cloud refers to a cloud environment similar to a public cloud with the exception that it is operated solely for a single organization.

In aspects, the cloud-computing environment 102 can comprise a variety of centralized or decentralized computing devices. For example, the cloud-computing environment 102 may include a mobile device, a laptop computer, a desktop computer, grid-computing resources, a virtualized computing resource, cloud-computing resources, peer-to-peer distributed computing devices, a server, a server farm, or a combination thereof. The cloud-computing environment 102 may be centralized in a single room, distributed across different rooms, distributed across different geographic locations, or embedded within a network 122.

In aspects, and as shown in FIG. 1, the computing devices of the cloud-computing environment 102 may have various software modules stored thereon to enable the functions of the system 100. In aspects, these modules can include a data preparation module 106, a LLM 110, a post-processing module 114, and a validation module 116. Each of these modules will be discussed in detail below.

The network 122 refers to a telecommunications network, such as a wired or wireless network. The network 122 can span and represent a variety of networks and network topologies. For example, the network 122 can include wireless communication, wired communication, optical communication, ultrasonic communication, or a combination thereof. For example, satellite communication, cellular communication, Bluetooth, Near Field Communications (NFC), Infrared Data Association standard (IrDA), wireless fidelity (WiFi), and worldwide interoperability for microwave access (WiMAX) are examples of wireless communication that may be included in the network 122. Cable, Ethernet, digital subscriber line (DSL), fiber optic lines, fiber to the home (FTTH), and plain old telephone service (POTS) are examples of wired communication that may be included in the network 122. Further, the network 122 can traverse a number of topologies and distances. For example, the network 122 can include a direct connection, personal area network (PAN), local area network (LAN), metropolitan area network (MAN), wide area network (WAN), or a combination thereof.

In aspects, and as shown in FIG. 1, the system 100 can perform its functions by first receiving structured data 104 from a data source. The data source may be, for example a computer or database storing the structured data 104. The structured data 104 refers to data that is organized in a standardized format that is easy to access and process. In aspects, the structured data 104 may be in tabular format with rows and columns that define the data attributes. In aspects, the structured data 104 can represent an account, for example a financial account with transaction information, for example credit card transactions of a credit card account holder of a bank. The data attributes can represent data related to transactions of the account holder over a period of time. In aspects, data attributes can include, but are not limited to, account numbers, transaction-posting date, transaction date, transaction amount, whether the transaction was a debit or credit, merchant identifiers associated with transactions, merchant names, etc.

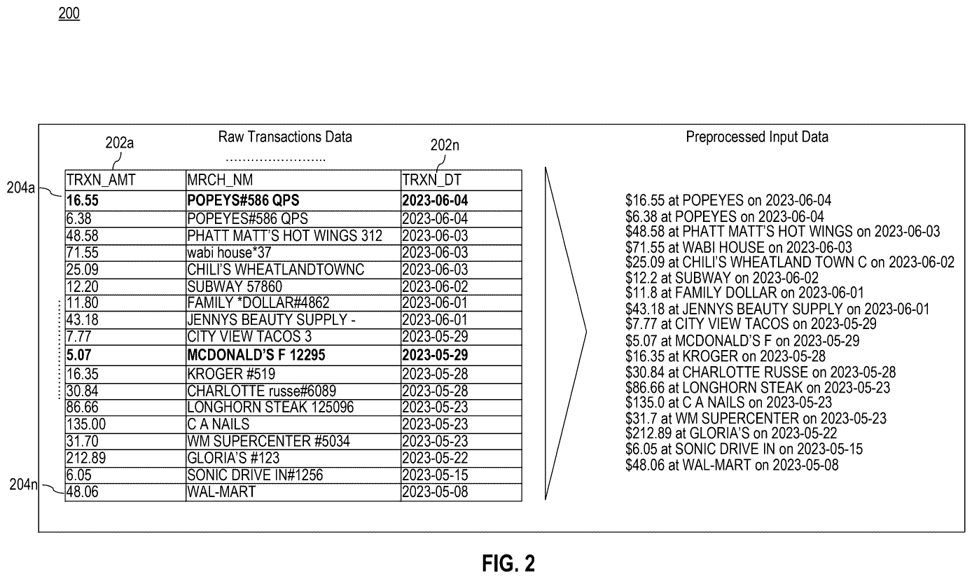

In aspects, the structured data 104 may be received by the data preparation module 106. The data preparation module 106 refers to a software program and/or class of software libraries that when executed by one or more computing devices, performs functions to shape the structured data 104 into a desired format for input into the LLM 110. For example, the data preparation module 106 can generate one or more natural language sentences from the structured data 104. The one or more natural language sentences refer to template sentences specifically engineered to fit a certain format, in which attributes of the structured data 104 may be inserted or used to form the sentences. In aspects, the data preparation module 106 can generate the one or more natural language sentences by using pre-defined templates that are auto-filled with the attributes of the structured data 104. The data preparation module 106 can do this by parsing the structured data 104 and recognize attributes, and where to insert those attributes. Once recognized, the attributes of a particular row of the structured data 104 may be inserted into the templates based on computer-implemented rules and/or logic. FIG. 2 shows how one or more natural language sentences are generated from structured data 104 according to aspects by the data preparation module 106. In aspects, and as shown in FIG. 2, each of the columns (shown as {202a, . . . 202n}) of the table shown represents an attribute of the account while the rows (shown as {204a, . . . 204n}) show values for those attributes. In aspects, the data preparation module 106 can parse the table for the attribute/value pairs and execute rules or software code to convert these attribute/value pairs into natural language sentences. For example, the data preparation module 106 may be given a template to follow as shown below:
[Transaction Amount] at [Merchant] on [Date]

In the template shown above, Transaction amount represents the dollar amount of the transaction, Date represents the date of the transaction, and Merchant represents the name of the merchant which was transacted with. In aspects, the data preparation module 106 can generate the one or more natural language sentences by parsing the table and forming the one or more natural language sentences by filling in the attribute/values from the table into the template. The right side of FIG. 2 shows example natural language sentences that may be generated. In aspects, the function of the data preparation module 106 may be implemented using software libraries of computer languages such as Python or Perl, or other similar programming languages to perform the parsing, extraction, and sentence generation operations.

In aspects, the data preparation module 106 can perform a data cleaning function as a part of the generation of the one or more natural language sentences, where irrelevant and extraneous characters and numbers may be removed from the attributes. For example, irrelevant numbers may be removed from merchant names. In this way, the data may be cleaned so as to reduce chances that the LLM 110 will become confused when processing the data.

In aspects, once the data preparation module 106 generates the one or more natural language sentences, the data preparation module 106 can perform further processing by generating prompts 108, using the one or more natural language sentences that may be input into a LLM (e.g., LLM 110). The prompts 108 refer to custom and structured inputs that when input into the LLM 110, allow the LLM 110 to understand the prompts 108 and allow the LLM 110 to provide meaningful insights based on the prompts 108. In aspects, and in the instant application, the prompts 108 can perform a primary function of allowing the LLM 110 to analyze the transaction data and allow the LLM 110 to give a set of top attributes that characterize the account holder's preferences based on the transactions data. For example, the LLM 110 can provide a top three preferences as keywords best summarizing the account holder's preferences.

In aspects, subject matter experts can engineer aspects of the prompts 108. Subject matter experts may be individuals such as data scientists, computer scientists, engineers, or system administrators. The subject matter experts can generate aspects of the prompts 108, based on learned insights that can inform ways to get the LLM 110 to generate meaningful insights regarding preferences based on the one or more natural language sentences. In other aspects, the generation of the prompts 108 may be partially automated based on the subject matter experts engineering aspects of the prompts 108, and then using a prompt programming framework such as the DSPy framework, available through the Stanford NLP library of Stanford University of California, for algorithmically optimizing the prompts 108.

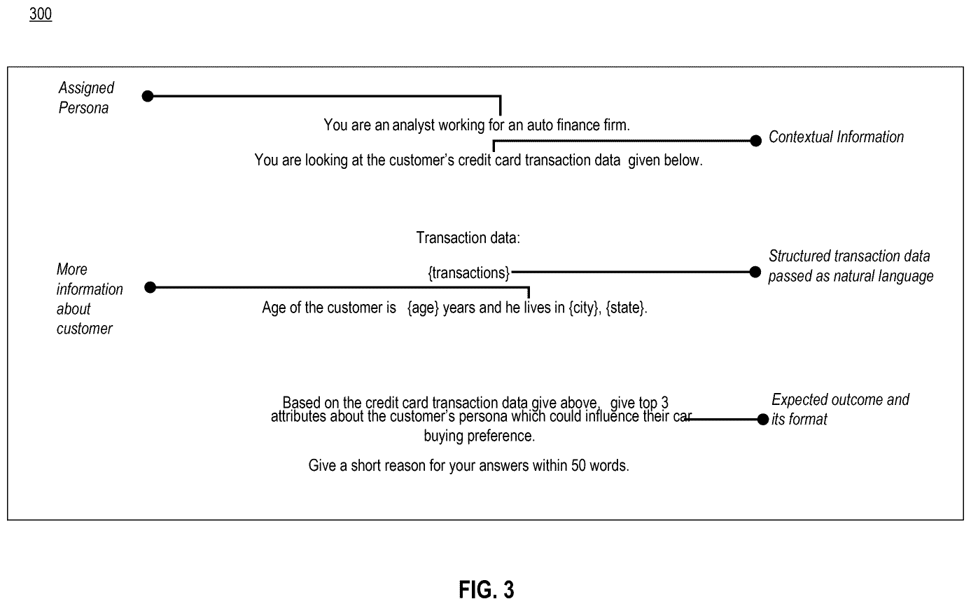

In aspects, the data preparation module 106 can take the aspects of the prompts 108 and modify them to insert the one or more natural language sentences into them and also insert any other data necessary to generate the full prompts 108. FIG. 3 shows an example prompt 300 generated to determine preferences of a user according to aspects. FIG. 3 shows an example prompt 300 generated to determine account holder preferences based on transactions data according to aspects. In aspects, the prompt 300 can include several parts.

First, the prompt 300 can include contextual information. The contextual information refers to a portion of the prompt 300 that sets the context to provide a clear understanding of the situation being discussed. The contextual information provides background information that informs how to approach the task to the LLM 110. In FIG. 3, it is assumed that the account looked at belongs to a bank customer and the transaction data is that of credit card transactions of the bank customer, and therefore the contextual information indicates to the LLM 110 “[y]ou are looking at the customer's credit card transaction data.” Thus, the contextual information puts a boundary on, and defines the overall task to be performed by the LLM 110.

Second, the prompt 300 can include specific information about the account holder. For example, the prompt 300 can include information about age, location, employment status, income, etc. of the account holder. This information is to provide more specific information about the subject of the prompt that may inform the LLM 110 about the potential preferences.

Third, the prompt 300 can assign a persona to the LLM 110. The persona refers to a perspective that the LLM 110 is to view the one or more natural language sentences. LLMs may be assigned a persona, i.e., the perspective they need to “behave like” while analyzing data. The persona defines the characteristics, perspective, and the tone that the LLM 110 should adopt when generating a response. In FIG. 3, this persona is shown as that of an “analyst working for an auto finance firm.”

Fourth, the prompt 300 will have the one or more natural language sentences. This was previously discussed above and will not be elaborated on further.

Fifth, the prompt 300 can indicate what an expected outcome of the LLM 110 should be and its format. The expected outcome tells the LLM 110 what type of outputs are expected and ensures that the LLM 110 generates responses that are accurate, informed, and appropriate to the specific data set provided. In FIG. 3, the expected outcome is “give top 3 attributes about the customer's persona which could influence their car buying preference.” The LLM 110 is also asked to “[g]ive a short reason for [the] answers within 50 words.”

Going back to FIG. 1, after the prompts 108 are generated, the data preparation module 106 can pass the prompts 108 to the LLM 110 so that the LLM 110 can run its inferences and generate outputs. The LLM 110 described in this disclosure may be any one of the known LLMs used in industry. In aspects, the LLM 110 can run the output through its neural network or transformer networks and based on its training, can generate outputs.

In aspects, and based on the prompts 108, the LLM 110 can generate its output(s). In the present disclosure, since one prompt is given, one output is generated indicating the top three preferences along with a reason for each preference determined. In aspects, the output of the LLM 110 may be passed to the post-processing module 114. The post-processing module 114 refers to a software program and/or class of software libraries that when executed by one or more computing devices, performs functions to categorize and map the preferences determined by the LLM 110 to specific customer and preferred product attributes. The customer attributes refer to keywords that are meant to summarize or characterize the preferences as determined by the LLM 110 output. The preferred product attributes refer to keywords that summarize or characterize the customer attributes but to a particular product, category of product, or service. Thus, the preferences, customer attributes, and product attributes form layers of abstraction that can map an account holder's transactions behavior to specific attributes for products and services that they may be interested in.

In aspects, the post-processing module 114 can perform its functions by receiving the first output of the LLM 110 and analyzing the output and preferences determined, and map the first output to pre-determined customer attributes that summarize or characterize the preferences. In aspects, the post-processing module 114 can perform the mapping by implementing a clustering algorithm that can take the keywords in the first output and map them to a vector space. In the vector space, the keywords may be measured using a Euclidean distance to determine how close they are to pre-determined customer attributes. The clustering algorithm may be any number of clustering algorithms, such as a K-Means algorithm or similar algorithms.

The above process may be illustrated by way of example. In aspects, assuming that the first output yields that the top three preferences of the account holder, based on the transaction data. In aspects the preferences can indicate that the account holder is price conscious, because they frequently purchase from budget-friendly retailers like Family Dollar, Kroger, and Walmart; is a foodie because they frequently spend money on food, including fast food, restaurants, and food trucks; and is style-conscious because they frequently purchase from beauty supply stores and a nail salon, suggesting an interest in personal grooming and style. Based on these preferences, and reasons given by the LLM 110, the post-processing module 114 can pass the preferences to the clustering algorithm, which can determine where these preferences are located in relation to pre-determined customer attributes in a vector space. The location indicates a measure of closeness. Thus the closer the preferences are to the customer attributes, the closer they are in concept to one another.

In aspects, the pre-determined customer attributes may be any number of categories that have been pre-determined by subject matter experts. These categories can define or categorize individuals as being interested in certain activities, concepts, causes, or can be personality types, personality traits, physical traits, etc. that are described by keywords. For example, the customer preferences may be “foodie,” “tech-savvy,” “frequent traveler,” “busy lifestyle,” “fashion conscious,” “health conscious,” “affluence,” “environment conscious,” “leisure enthusiast,” “outdoor enthusiast,” “home improvement focus,” “budget conscious,” etc. These are only some examples and are not limiting. Any number of customer attributes may be created.

In aspects, the preference (i.e., the keywords indicating the preferences output by the LLM 110) can be measured against these customer attributes. Again, and as indicated previously, this can be done by taking a Euclidean distance in the vector space to determine the closest customer attributes to the preferences. Closest refers to within a pre-determined threshold or distance of the preferences to the customer attributes.

In aspects, once the customer attributes are determined, the post-processing module 114 can further map the customer attributes to preferred product attributes. The preferred product attributes refer to keywords that summarize or characterize the customer attributes and relate them to a particular product or service. Take for example a vehicle (e.g., car, boat, truck, motorcycle, bicycle, etc.). If the product is a vehicle, certain keywords can be used to define characteristics or features of vehicles. For examples, vehicles can be luxury, economy, SUV, truck, sport, fuel efficient, gas powered, electric powered, hybrids. They can also have certain features such as leather interior, cloth interior, sun roof, moon roof, touchscreens, automatic transmission, advance infotainment systems, additional cargo space, roof racks, hitches, etc. As can be seen any number of characteristics or features can be attributed to vehicles. These can be referred to as product attributes.

In aspects, and as it relates to this disclosure, these product attributes can be mapped to the customer attributes. For example, the customer attribute of “budget conscious” can map to product attributes of affordable, reliable, fuel efficient, and/or low maintenance. The consumer attribute of “fashion conscious” can map to aesthetic, sleek design, premium interior, luxury, and/or sport. In aspects, this customer attribute mapping to product attribute mapping can relate the customer attributes to specific product attributes. In aspects, these mappings can be pre-determined by a subject matter expert that has determined what customer attributes to map to product attributes. The specific customer attributes that are a result of the outputs of the LLM 110 and that are mapped to the product attributes are referred to as the preferred product attributes. Preferred refers to the preferences of the account holder.

In aspects, once the preferred product attributes are obtained, these can be used in a variety of ways. In aspects, the preferred product attributes can be passed to downstream components. The downstream components can be for example downstream components 118. For example, the downstream components 118 can include report-generating software that can take the preferred product attributes and generate reports in natural language formats and with graphics, and that are understandable to a human. The reports can be used to inform decisions about purchasing preferences of the account holder, personalized marketing, personalized product design, custom services, etc. For example, the reports can be used to determine what vehicle to market to the account holder, what financing terms to offer, etc. Again, these are merely exemplary use cases. In addition to reports, downstream components 118 can encompass further downstream digital systems that use the preferred product attributes as inputs for their algorithms. For example, a downstream digital system can be a content delivery network that can use the preferred product attributes to develop custom digital content that can then be delivered to the account holder via cable, internet, e-mail, in-application, push notifications, or other digital platforms. This can also be extended to non-digital platforms such as direct mail, where the same content is delivered via non-digital means (e.g., pamphlets, fliers, etc.) based on the preferred product attributes. While the scope of the downstream components 118 is beyond the scope of this disclosure, it is sufficient for a POSA to recognize what type of tools may be included based on a reading of this disclosure.

In aspects, once the post-processing module 114 performs its functions, the preferred product attributes may be optionally passed to the validation module 116. The validation module 116 refers to a software program and/or class of software libraries that when executed by one or more computing devices, performs functions to assist in validating the outputs of the LLM 110 (i.e., assessing the accuracy of the outputs against available benchmarks). This may be done by having the validation module 116 perform comparisons of the preferred product attributes the LLM 110 generates for each account holder with actual, real-life, and/or pre-existing information of known product sales to the account holder. The insights obtained from these comparison can help identify whether the LLM 110 is providing useful insights, and will ultimately help in improving the data preparation of the data preparation module 106, the prompt engineering when developing the prompts 108, as well as post-processing functions of the post-processing module 114, for subsequent iterations of the system 100, when the system 100 processes further structured data 104. Thus, the validation module 116 helps in improving the overall quality of the LLM 110 output. The validation module 116 can also be used in a “training” stage of the system 100 when refining the rules of the data preparation module 106 and/or the prompts 108.

In aspects, the validation module 116 can function by receiving pre-existing information of known product sales to the account holder. These can be received, by for example, having subject matter expert inputs 120 representing this data, which are input into the validation module 116 by the subject matter experts. This can be done via a graphical user interface, data files, and/or through application programming interfaces (APIs). Taking the example of vehicles as the product of interest, in aspects, the pre-existing information can be that of known sales of vehicles to the account holder. Thus, if sales of vehicles to the account holder are known, the product attributes of those vehicles can be compared to the preferred product attributes determined by the LLM 110 in order to determine whether they align with each other and/or how close they are together. This can be done, for example, again using a clustering algorithm (e.g., a K-Means algorithm) to map the product attributes of known products sold to the account holder, to the preferred product attributes output by the LLM 110 to determine a measure of closeness between the two. Again, the clustering algorithm can be the K-means clustering algorithm or similar algorithm. In order to validate the closeness, similar attributes should fall within a predetermined threshold distance to one another. If, for example, it is determined that both sets of attributes all fall close to one another, it can be concluded that the LLM 110 is providing valid (i.e., close) results. If, however, there is a discrepancy or large distance between the preferred product attributes and the product attributes of known products sold to the account holder, it can be determined that the LLM 110 is not providing valid results, or that the system 100 needs to be tuned to optimize for better results. This tuning can be, for example, to engineer better prompts 108 or to better format the structured data 104 for the LLM 110.

The functions of the system 100 may be performed by the modules or units of the backend computing devices of the system 100, for example the computing devices of the cloud-computing environment 102. The modules or units may be implemented as instructions stored on a non-transitory computer readable medium to be executed by one or more computing units such as a processor, a special purpose computer, an integrated circuit, integrated circuit cores, or a combination thereof. The non-transitory computer readable medium may be implemented with any number of memory units, such as a volatile memory, a nonvolatile memory, an internal memory, an external memory, or a combination thereof. The non-transitory computer readable medium may be integrated as a part of the system 100, or installed as a removable portion of the system 100.

It has been discovered that the system 100 described above can help improve LLMs achieve a significant quality in the output when identifying behavioral patterns. The system 100 augments existing LLMs by providing a framework and a feedback mechanism that may be used to identify patterns in behavior that can provide insights into user preferences. These insights into preferences can then be used in a variety of application, from product marketing, product design, custom services, etc. As indicated, traditional methods of deducing user preferences is usually done by surveying people and asking them questions about likes/dislikes, interests, preferences, etc. For example, a person can fill out questionnaires or surveys with questions designed to extract these preferences. However, such questionnaire and survey data may not yield accurate results because a person may not answer the questions correctly, truthfully, or otherwise. Also, these surveys only capture preferences for a given instance in time. They do not account for changing patterns in the user's preferences or behaviors. These can vary significantly over time or under various circumstances.

Additionally, the system 100 can be extended to other application depending on the structured data 104 used. These applications can include healthcare and fraud detection as examples. For example, the system 100 can be modified to take in health related data and deduce patterns based on the health data. Such data can then be used to determine potential causes for health problems and diseases, which can then be used in healthcare treatment and/or preventative care. In another application, if the structured data 104 relates to bank transactions, another use case is to detect patterns in the transactions to indicate money laundering or fraud detection.

As indicated, detection of these patterns is complex and nuanced. Typical computer-implemented systems in conjunction with humans, and/or humans alone cannot detect these patterns. The advent of AI/ML technologies has helped humans detect ever nuanced patterns from data. The disclosed system 100 improves on existing AI/ML technologies by further providing tools to augment the AI/ML tools to tailor those tools for a specific task. Thus, the system 100 provides an overall improvement in technology, namely AI/ML, and more specifically LLMs.

### Methods of Operation

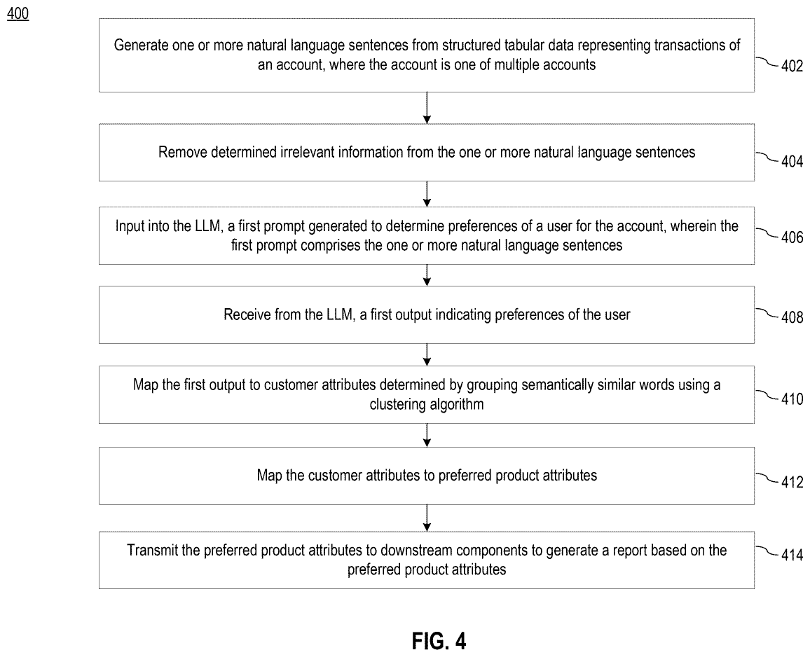

FIG. 4 is an example method 400 of operating the system 100 according to aspects. Method 400 may be implemented on computing devices, for example the computing devices of the cloud-computing environment 102.

In aspects, method 500 may begin by generating one or more natural language sentences from structured tabular data 104 representing transactions of an account as shown in step 402. In aspects, the account can be an account of a credit card account holder of a bank. In aspects, the account can be one of multiple accounts. In aspects, the one or more natural language sentences can be generated using the data preparation module 106. In aspects, the data preparation module 106 can further remove determined irrelevant information from the one or more natural language sentences, as shown in step 404. Once the one or more natural language sentences are in a format that can be input into the LLM 110, the data preparation module 106 inputs them into the LLM 110 via a prompt generated to determine preferences of the account holder for the account, as shown in step 406. The prompt includes the one or more natural language sentences. In aspects, the LLM 110 can process the prompt and generate a first output indicating preferences of the account holder. This first output can be received by downstream components, for example the post-processing module 114, as shown in step 408. In aspects, the post-processing module 114 can map the first output to customer attributes determined by grouping semantically similar words using a clustering algorithm, as shown in step 410. The clustering algorithm can be, for example, a K-Means algorithm. In aspects, the post-processing module 114 can further map the customer attributes to preferred product attributes, as shown in step 412. In aspects, once obtained, the preferred product attributes can be transmitted to downstream components to perform other functions based on the preferred product attributes, as shown in step 414. One of these functions can be to generate a report based on the preferred product attributes indicating what potential products the account holder will want.

The operation of method 400 is performed, for example, by system 100, in accordance with aspects described above. The functions described may be performed according to and consistent with FIGS. 1-3, and by the data preparation module 106, the LLM 110, the post-processing module 114, and the validation module 116 or their equivalents as described above. Such modules may be combined in various ways or manners to perform the functions described with respect to method 500.

### Components of the System

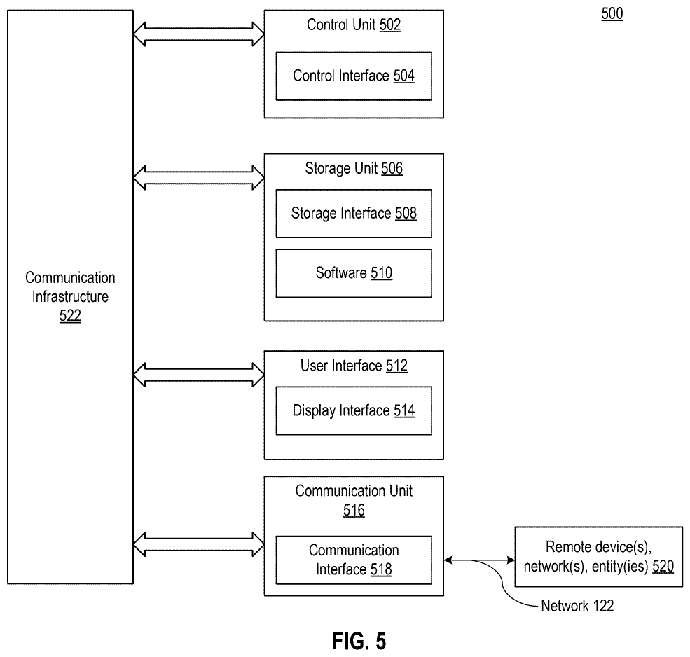

FIG. 5 is an example architecture 500 of the components that may be used to implement the computing devices of the system 100 according to aspects. The components may be implemented on any of the devices of the system 100, for example the computing devices of the cloud-computing environment 102. In aspects, the components may include a control unit 502, a storage unit 506, a communication unit 516, and a user interface 512. The control unit 502 may include a control interface 504. The control unit 502 may execute software 510 to provide some or all of the intelligence of system 100. The control unit 502 may be implemented in a number of different ways. For example, the control unit 502 may be a processor (e.g., central processing unit (CPU) or a graphics processing unit (GPU)), an application specific integrated circuit (ASIC), an embedded processor, a microprocessor, a hardware control logic, a hardware finite state machine (FSM), a digital signal processor (DSP), a field programmable gate array (FPGA), or a combination thereof.

The control interface 504 may be used for communication between the control unit 502 and other functional units or devices of system 100. The control interface 504 may also be used for communication that is external to the functional units or devices of system 100. The control interface 504 may receive information from the functional units or devices of system 100, or from remote devices 520, or may transmit information to the functional units or devices of system 100, or to remote devices 520. The remote devices 520 refer to devices external to system 100, such as any interfaces or computers used by subject matter experts to interact with the system 100 and provide the subject matter expert inputs 120, or the computers of the downstream components 118, or from computers that the structured data 104 is received.

The control interface 504 may be implemented in different ways and may include different implementations depending on which functional units or devices of system 100 or remote devices 520 are being interfaced with the control unit 502. For example, the control interface 504 may be implemented with integrated circuits, optical circuitry, waveguides, wireless circuitry, wireline circuitry to attach to a bus, an application programming interface (API), or a combination thereof. The control interface 504 may be connected to a communication infrastructure 522, such as a bus, to interface with the functional units or devices of system 100 or remote devices 520.

The storage unit 506 may store the software 510. For illustrative purposes, the storage unit 506 is shown as a single element, although it is understood that the storage unit 506 may be a distribution of storage elements. Also for illustrative purposes, the storage unit 506 is shown as a single hierarchy storage system, although it is understood that the storage unit 506 may be in a different configuration. For example, the storage unit 506 may be formed with different storage technologies forming a memory hierarchical system including different levels of caching, main memory, rotating media, or off-line storage. The storage unit 506 may be a volatile memory, a nonvolatile memory, an internal memory, an external memory, or a combination thereof. For example, the storage unit 506 may be a nonvolatile storage such as nonvolatile random access memory (NVRAM), Flash memory, disk storage, or a volatile storage such as static random access memory (SRAM) or dynamic random access memory (DRAM).

The storage unit 506 may include a storage interface 508. The storage interface 508 may be used for communication between the storage unit 506 and other functional units or devices of system 100. The storage interface 508 may also be used for communication that is external to system 100. The storage interface 508 may receive information from the other functional units or devices of system 100 or from remote devices 520, or may transmit information to the other functional units or devices of system 100 or to remote devices 520. The storage interface 508 may include different implementations depending on which functional units or devices of system 100 or remote devices 520 are being interfaced with the storage unit 506. The storage interface 508 may be implemented with technologies and techniques similar to the implementation of the control interface 504.

The communication unit 516 may enable communication to devices, components, modules, or units of system 100 or to remote devices 520. For example, the communication unit 516 may permit the system 100 to communicate between the modules of the cloud-computing environment 102. The communication unit 516 may further permit the devices of system 100 to communicate with remote devices 520 such as an attachment, a peripheral device, or a combination thereof, through the network 122.

As previously indicated, the network 122 may span and represent a variety of networks and network topologies. For example, the network 122 may include wireless communication, wired communication, optical communication, ultrasonic communication, or a combination thereof. For example, satellite communication, cellular communication, Bluetooth, Infrared Data Association standard (IrDA), wireless fidelity (WiFi), and worldwide interoperability for microwave access (WiMAX) are examples of wireless communication that may be included in the network 122. Cable, Ethernet, digital subscriber line (DSL), fiber optic lines, fiber to the home (FTTH), and plain old telephone service (POTS) are examples of wired communication that may be included in the network 122. Further, the network 122 may traverse a number of network topologies and distances. For example, the network 122 may include direct connection, personal area network (PAN), local area network (LAN), metropolitan area network (MAN), wide area network (WAN), or a combination thereof.

The communication unit 516 may also function as a communication hub allowing system 100 to function as part of the network 122 and not be limited to be an end point or terminal unit to the network 122. The communication unit 516 may include active and passive components, such as microelectronics, communications circuitry, Radio Frequency (RF) circuitry, or an antenna, for interaction with the network 122.

The communication unit 516 may include a communication interface 518. The communication interface 518 may be used for communication between the communication unit 516 and other functional units or devices of system 100 or to remote devices 520. The communication interface 518 may receive information from the other functional units or devices of system 100, or from remote devices 520, or may transmit information to the other functional units or devices of the system 100 or to remote devices 520. The communication interface 518 may include different implementations depending on which functional units or devices are being interfaced with the communication unit 516. The communication interface 518 may be implemented with technologies and techniques similar to the implementation of the control interface 504.

The user interface 512 may present information generated by system 100. In aspects, the user interface 512 allows a user to interface with the devices of system 100 or remote devices 520. The user interface 512 may include an input device and an output device. Examples of the input device of the user interface 512 may include a keypad, buttons, switches, touchpads, soft-keys, a keyboard, a mouse, or any combination thereof to provide data and communication inputs. Examples of the output device may include a display interface 514. The control unit 502 may operate the user interface 512 to present information generated by system 100. The control unit 502 may also execute the software 510 to present information generated by system 100, or to control other functional units of system 100. The display interface 514 may be any graphical user interface such as a display, a projector, a video screen, or any combination thereof.

The above detailed description and aspects of the disclosed system 100 are not intended to be exhaustive or to limit the disclosed system 100 to the precise form disclosed above. While specific examples for system 100 are described above for illustrative purposes, various equivalent modifications are possible within the scope of the disclosed system 100, as a POSA will recognize. For example, while processes and methods are presented in a given order, alternative implementations may perform routines having steps, or employ systems having processes or methods, in a different order, and some processes or methods may be deleted, moved, added, subdivided, combined, or modified to provide alternative or sub-combinations. Each of these processes or methods may be implemented in a variety of different ways. Also, while processes or methods are at times shown as being performed in series, these processes or blocks may instead be performed or implemented in parallel, or may be performed at different times.

The resulting methods and system 100 are cost-effective, highly versatile, and accurate, and may be implemented by adapting components for ready, efficient, and economical manufacturing, application, and utilization. Another important aspect of the present disclosure is that it valuably supports and services the historical trend of reducing costs, simplifying systems, and/or increasing performance.

These and other valuable aspects of the aspects of the present disclosure consequently further the state of the technology to at least the next level. While the disclosed aspects have been described as the best mode of implementing system 100, it is to be understood that many alternatives, modifications, and variations will be apparent to those skilled in the art in light of the descriptions herein. Accordingly, it is intended to embrace all such alternatives, modifications, and variations that fall within the scope of the included claims. All matters set forth herein or shown in the accompanying drawings are to be interpreted in an illustrative and non-limiting sense. Accordingly, the scope of the disclosure should be determined not by the aspects illustrated, but by the appended claims and their equivalents.

What is claimed is:

1. A computer-implemented method for augmenting a large language model (LLM) for identifying preferences, the method comprising:
(a) generating, by one or more computing devices, one or more natural language sentences from structured tabular data representing transactions of an account, where the account is one of multiple accounts;
(b) removing determined irrelevant information from the one or more natural language sentences;
(c) inputting into the LLM, a prompt generated to determine preferences of an account holder for the account, wherein the prompt comprises the one or more natural language sentences;
(d) receiving from the LLM, a first output indicating preferences of the account holder;
(e) mapping the first output to customer attributes determined by grouping semantically similar words using a clustering algorithm;
(f) mapping the customer attributes to preferred product attributes; and
(g) transmitting the preferred product attributes to downstream components to generate a report based on the preferred product attributes.

2. The method of claim 1, further comprising:
(h) validating the mapping in (f) using pre-existing information of known sales to the account holder.

3. The method of claim 2, further comprising repeating (a)-(h) for further accounts of the multiple accounts.

4. The method of claim 2, wherein the pre-existing information comprises information regarding previous sales of a product to the account holder.

5. The method of claim 4, wherein the validating comprises:
grouping the pre-existing information and the preferred product attributes using the clustering algorithm; and
determining a distance between the preferred product attributes to the pre-existing information to determine a measure of closeness between the preferred product attributes and the pre-existing information.

6. The method of claim 4, wherein the clustering algorithm is a K-Means algorithm.

7. The method of claim 1, wherein the preferred product attributes are those related to a vehicle.

8. A non-transitory computer readable medium including instructions for augmenting a large language model (LLM) for identifying preferences, that when executed by one or more processors, causes the one or more processors to perform operations comprising:
(a) generating one or more natural language sentences from structured tabular data representing transactions of an account, where the account is one of multiple accounts;
(b) removing determined irrelevant information from the one or more natural language sentences;
(c) inputting into the LLM, a prompt generated to determine preferences of an account holder for the account, wherein the prompt comprises the one or more natural language sentences;
(d) receiving from the LLM, a first output indicating preferences of the account holder;
(e) mapping the first output to customer attributes determined by grouping semantically similar words using a clustering algorithm;
(f) mapping the customer attributes to preferred product attributes; and
(g) transmitting the preferred product attributes to downstream components to generate a report based on the preferred product attributes.

9. The non-transitory computer readable medium of claim 8, wherein the operations further comprise:
(h) validating the mapping in (f) using pre-existing information of known sales to the account holder.

10. The non-transitory computer readable medium of claim 9, wherein the operations further comprise repeating (a)-(h) for further accounts of the multiple accounts.

11. The non-transitory computer readable medium of claim 9, wherein the pre-existing information comprises information regarding previous sales of a product to the account holder.

12. The non-transitory computer readable medium of claim 11, wherein the validating comprises:
grouping the pre-existing information and the preferred product attributes using the clustering algorithm; and
determining a distance between the preferred product attributes to the pre-existing information to determine a measure of closeness between the preferred product attributes and the pre-existing information.

13. The non-transitory computer readable medium of claim 11, wherein the clustering algorithm is a K-Means algorithm.

14. The non-transitory computer readable medium of claim 8, wherein the preferred product attributes are those related to a vehicle.

15. A computing system for augmenting a large language model (LLM) for identifying preferences comprising:
a memory configured to store instructions;
one or more processors, coupled to the memory and configured to process the stored instructions to:
(a) generate one or more natural language sentences from structured tabular data representing transactions of an account, where the account is one of multiple accounts;
(b) remove determined irrelevant information from the one or more natural language sentences;
(c) input into the LLM, a prompt generated to determine preferences of an account holder for the account, wherein the prompt comprises the one or more natural language sentences;
(d) receive from the LLM, a first output indicating preferences of the account holder;
(e) map the first output to customer attributes determined by grouping semantically similar words using a clustering algorithm;
(f) map the customer attributes to preferred product attributes; and
(g) transmit the preferred product attributes to downstream components to generate a report based on the preferred product attributes.

16. The system of claim 15, wherein the one or more processors are further configured to:
(h) validate the mapping in (f) using pre-existing information of known sales to the account holder.

17. The system of claim 16, wherein the one or more processors are further configured to repeat (a)-(h) for further accounts of the multiple accounts.

18. The system of claim 16, wherein the pre-existing information comprises information regarding previous sales of a product to the account holder.

19. The system of claim 18, wherein the validating is based on:
grouping the pre-existing information and the preferred product attributes using the clustering algorithm; and
determining a distance between the preferred product attributes to the pre-existing information to determine a measure of closeness between the preferred product attributes and the pre-existing information.

20. The system of claim 15, wherein the clustering algorithm is a K-Means algorithm.
